(19) United States
(12) Patent Application Publication
(10) Pub. No.: US 2002/0071158 A1
(43) Pub. Date: Jun. 13, 2002

(54) Secure optical interface for elevator systems

(76) Inventor: Rory Smith, Germantown, TN (US)

Correspondence Address: WHITE & CASE LLP, PATENT DEPARTMENT, 1155 AVENUE OF THE AMERICAS, NEW YORK, NY, 10036, US

(21) Appl. No.: 09/731,461

(22) Filed: Dec. 7, 2000

(51) Int. Cl. H04B 10/00

(52) U.S. Cl. 359/144; 359/152

(57) ABSTRACT

A wireless optical interface is described for providing communication between elevator diagnostic equipment and elevator control equipment. The interface comprises a first light transmitter/receiver element connected to the diagnostic equipment, and a second light transmitter/receiver element connected to the elevator control system, the first and second elements in light communication with each other. Each of the first and second light transmitter/receiver elements include a photo transistor/light emitting diode pair and associated circuitry for converting back and forth between electronic and light data formats.

### BACKGROUND OF THE INVENTION

1. Field of the Invention

The present invention relates generally to elevator systems and devices for communicating with the control units in such systems. In particular, the invention concerns a secure optical interface device for providing improved communication with elevator control units. The device provides an improved link, for example, between the controller and diagnostic tools used by elevator maintenance personnel (e.g. a laptop computer loaded with diagnostic software). The communication link provided by the optical interface is safer and more secure than existing communication devices.

2. Description of the Related Art

Present elevator control system use data interfaces that are standard in the industry. The interfaces typically used in elevator control systems are electrical interfaces, such as RS232 or RS485 connections. A new class of elevator has appeared on the market that is built without the traditional machine room. These machine room-less elevators have the control equipment located in the elevator shaft or in a closet. In order to log on to the elevator system, elevator maintenance personnel must access the control equipment and physically connect the necessary diagnostic equipment (usually a laptop computer) to the control equipment via the traditional interfaces. This can be difficult and dangerous. Therefore, it would be desirable to provide a improved device for connecting elevator diagnostic equipment to the control equipment.

### SUMMARY OF THE INVENTION

The above objectives are achieved through an optical interface device for providing communication between elevator diagnostic equipment and elevator control equipment. The interface device comprises a first light transmitter/receiver element connected to the diagnostic equipment, and a second light transmitter/receiver element connected to the elevator control system. The first and second elements are in light communication with each other.

Each light transmitter/receiver elements includes a photo transistor/light emitting diode pair and associated circuitry for converting electronic data into light data and vice versa. The photo transistor/light emitting diode pairs communicate data in light form, preferably infrared light. The data transferred between the first and second elements may be encrypted by an encrypting device to provide additional security. The optical interface device provides for two-way transmission of light data between the transmitter/receiver elements. The first element may be disposed in a suction cap attached to the end of a standard cable connected to the diagnostic equipment. The second light transmitter/receiver element is disposed in an optical port connected to the controller. In this instance, the suction cap of the first element may be placed over the optical port for engaging the optical port in order to align the first and second transmitter/receiver elements. The optical port may be disposed on a panel of the elevator control or may be disposed in a hallway serviced by the elevator, such as in a push-button station or position indicator in the hallway.

The interface provided by the invention is wireless. No true physical connection is required between the two transmitter/receiver elements. The optical wireless interface provides an additional level of security from interference and from hackers. The wireless interface also has additional immunity from electromagnetic interference and electrostatic discharge.

### DESCRIPTION OF THE DRAWINGS

FIG. 1A shows a perspective view of a laptop computer containing elevator diagnostic software having a first light transmitter/receiver element attached thereto.

FIG. 1B shows a cross section of the first transmitter/receiver element.

FIG. 2 shows a perspective view of a first embodiment of the invention.

FIG. 3 shows a perspective view of a second embodiment of the invention.

### DETAILED DESCRIPTION OF THE INVENTION

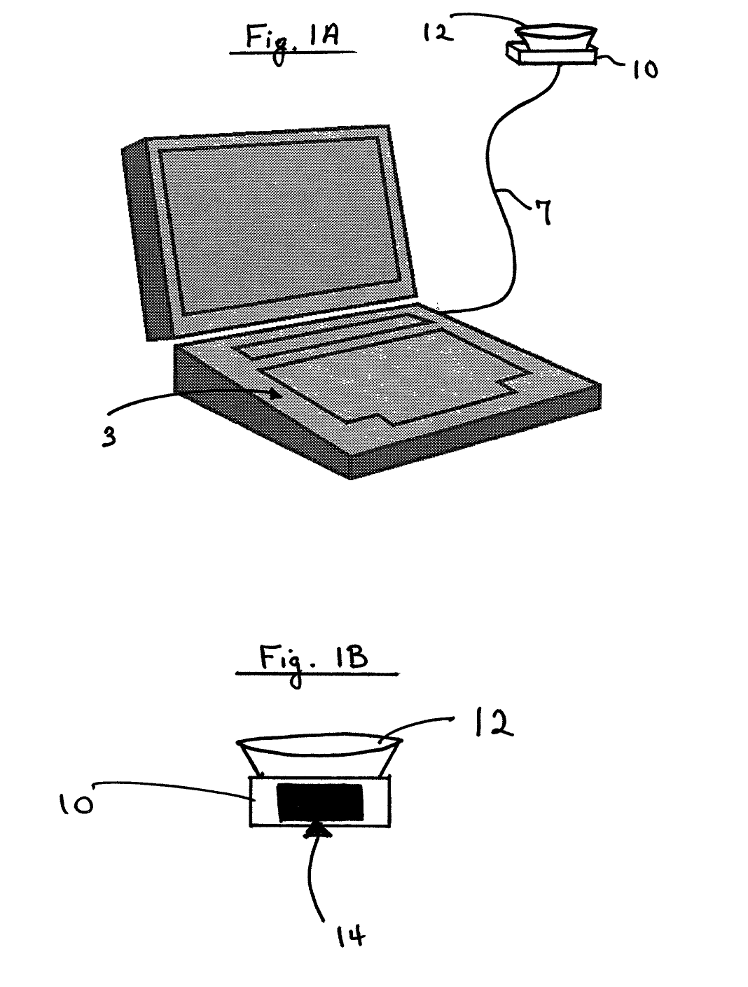

Referring to figures wherein like reference numerals designate like parts, FIG. 1 shows a laptop portable computer 3 containing elevator diagnostic software. A standard cable 7 connects that laptop to a first transmitter receiver element 10. The first element 10 includes a photo transistor/light emitting diode pair 14 and associated circuitry (see black box in FIG. 1B) to provide for the conversion of electronic data into a light format or from light to electronic format. In a preferred embodiment, the data is transmitted across the first and second elements as infrared light.

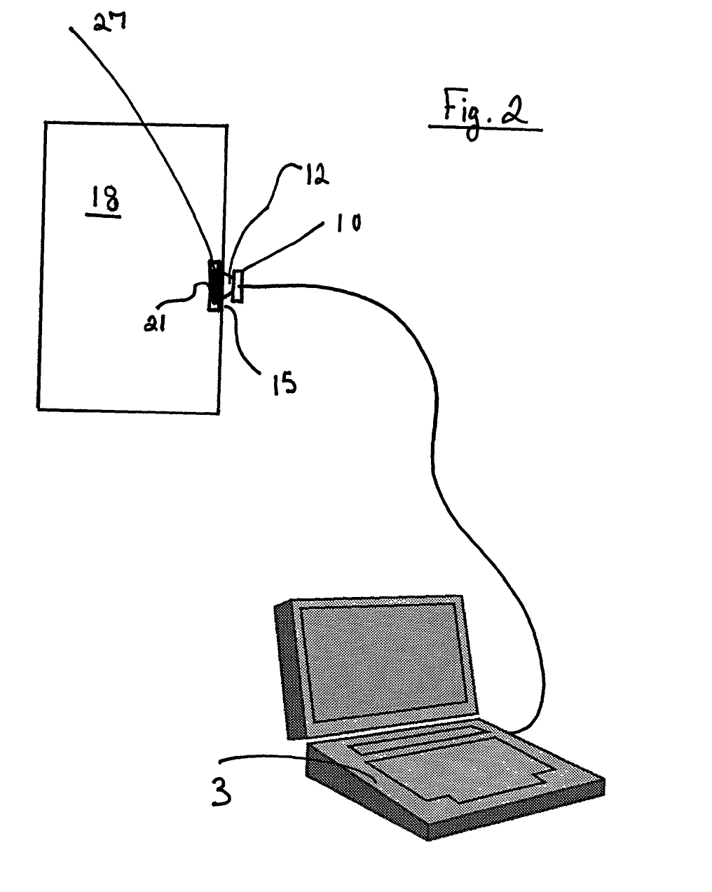

FIG. 2 shows laptop 3 with the first transmitter/receiver element 10 connected to an optical port 15 on a panel of an elevator controller 18. A second transmitter/receiver element 21 is disposed in the optical port 15. Like the first element, the second element includes a photo transistor/light emitting diode pair 27 and associate circuitry to provide for conversion of light and electronic data. A suction cap 12 attached to the first transmitter/receiver element 10 affixes the first element 10 to the optical port 15 so that the first and second elements are aligned with each other. Such alignment is needed to ensure efficient transfer of the light data.

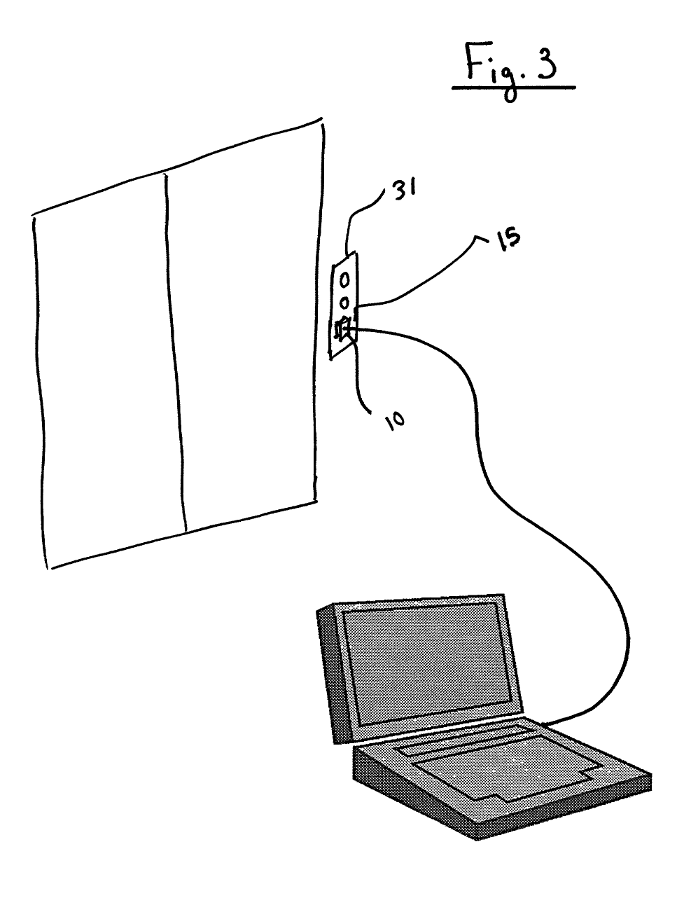

FIG. 3 shows another embodiment of the invention wherein the optical port 15 is disposed in an elevator push-button panel 31 located in the hallway of the building being serviced by the elevator. In this, instance the first transmitter/receiver element 10 is secured over the optical port 15 and anchored there by the suction cap 12.

The wireless communication interface between the first and second transmitter/receiver elements has unique advantages. First, no physical connection is required between the two elements. This reduces, if not eliminates, the risk of shock when the maintenance person connects the diagnostic equipment to the elevator. The device also provides for greater security in the transfer of data. Such security is especially enhanced if the data is encrypted via standard devices, such as in-line key encryption devices and the like.

What is claimed is:

1. An optical interface device for providing communication between elevator diagnostic equipment and elevator control equipment, the device comprising:
a first light transmitter/receiver element connected to the diagnostic equipment; and
a second light transmitter/receiver element connected to the elevator control system, the second element in light communication with the first element.

2. An optical interface device according to claim 1, wherein each of the first and second light transmitter/receiver elements comprises a photo transistor/light emitting diode pair.

3. An optical interface device according to claim 2, further comprising an encryption device for encrypting the data communicated between the first and second transmitter/receiver elements.

4. An optical interface device according to claim 3, wherein the first and second light transmitter/receiver elements provide for communication of data in the form of infrared light.

5. An optical interface device according to claim 4, wherein the first and second light transmitter/receiver elements provide for two-way communication.

6. An optical interface device according to claim 5, wherein the first light transmitter/receiver element is disposed in a suction cap and the second light transmitter/receiver element is disposed in an optical port connected to the controller, the suction cup for engaging the optical port to align the first and second transmitter/receiver elements.

7. An optical interface device according to claim 6, wherein the optical port is disposed in a hallway serviced by the elevator.

8. An optical interface device according to claim 7, wherein the optical port is disposed in a push-button station or position indicator in the hallway.
